(19) United States
(12) Patent Application Publication
(10) Pub. No.: US 2007/0019792 A1
(43) Pub. Date: Jan. 25, 2007

(54) ANSWERING MACHINE CAPABLE OF ACCESSING AN EXTERNAL STORAGE DEVICE

(76) Inventor: Hung-Yen Lin, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/163,862

(22) Filed: Nov. 1, 2005

(30) Foreign Application Priority Data
Jul. 1, 2005 (TW) 094211155

(51) Int. Cl. H04M 1/64

(52) U.S. Cl. 379/67.1

(57) ABSTRACT

An answering machine includes: an interface module for coupling an external line; a host device controller for coupling to an external storage device, wherein the host device controller is utilized for accessing the external storage device; a control circuit coupled to the interface module and the host device controller for controlling the host device controller to access the external storage device; and an audio output device coupled to the control circuit, wherein the audio output device is capable of being utilized for playing an audio message stored in the external storage device.

### BACKGROUND OF THE INVENTION

1. Field of the Invention

The present invention relates to answering machines, and more particularly, to an answering machine capable of accessing an external storage device.

2. Description of the Prior Art

Please refer to FIG. 1. FIG. 1 is a diagram of an answering machine 10 according to the prior art. The answering machine 10 comprises an interface circuit 12, a ringing detection device 14, a Digital Telephone Answering Device (DTAD) controller 16, a memory 18, an audio output device 20, an audio input device 22, a keypad 24, and a display device 26, where the keypad 24 comprises a plurality of keys/buttons (not shown). The DTAD controller 16 is capable of performing basic telephone-answering functions, and is well known in the art. Therefore, the DTAD controller 16 is not explained in detail here.

The interface circuit 12 and the ringing detection device 14 are both coupled to an external line 60. The ringing detection device 14 is capable of performing ringing detection on the external line 60. The DTAD controller 16 is capable of controlling the interface circuit 12 to be in an on-hook state or an off-hook state according to the ringing detection performed by the ringing detection device 14. When the ringing detection device 14 detects ringing signals at the external line 60, the DTAD controller 16 is capable of controlling whether the interface circuit 12 switches from the on-hook state to the off-hook state according to whether the number of rings of a phone-call reaches a predetermined value or according to whether a ringing time of the phone-call reaches a predetermined time. Once the number of rings or the ringing time of the phone-call matches the corresponding predetermined criterion mentioned above, the DTAD controller 16 controls the interface circuit 12 to switch from the on-hook state to the off-hook state, in order to receive an audio message of a caller who makes the phone-call. The audio message of the caller is transmitted from the external line 60 through the interface circuit 12 to the DTAD controller 16, and stored in the memory 18, where a tape can be utilized for replacing the memory 18 in order to store the audio message.

The display device 26 is capable of being utilized for displaying that the answering machine 10 stores the audio message. A user of the answering machine 10 may utilize the keypad 24 to control the answering machine 10, in order to play the audio message. During the process of playing the audio message, the DTAD controller 16 reads recorded data of the audio message from the memory 18 and plays the audio message by utilizing the audio output device 20.

However, as the memory 18 of the answering machine 10 is fixed within the answering machine 10, it is not easy to carry the recorded data of the audio message to other places for further playback or utilization.

### SUMMARY OF THE INVENTION

It is an objective of the claimed invention to provide an answering machine capable of accessing an external storage device (i.e., reading/writing data in the external storage device).

According to one embodiment of the claimed invention, an answering machine comprises: an interface module for coupling an external line; a host device controller for coupling to an external storage device, wherein the host device controller is utilized for accessing the external storage device; a control circuit coupled to the interface module and the host device controller for controlling the host device controller to access the external storage device; and an audio output device coupled to the control circuit, wherein the audio output device is capable of being utilized for playing an audio message stored in the external storage device.

According to one embodiment of the claimed invention, the external storage device can be a storage device including a Universal Serial Bus (USB) interface, and the host device controller is a USB host device controller accordingly.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an answering machine according to the prior art.

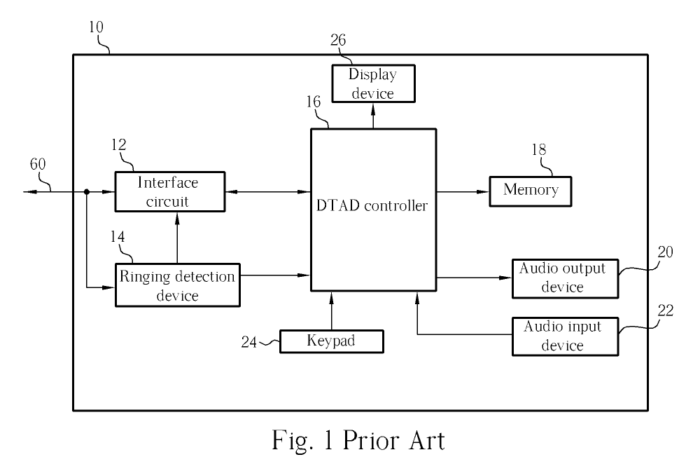

FIG. 2 is a diagram of an answering machine according to a first embodiment of the present invention.

FIG. 3 is a diagram of an answering machine according to a second embodiment of the present invention.

### DETAILED DESCRIPTION

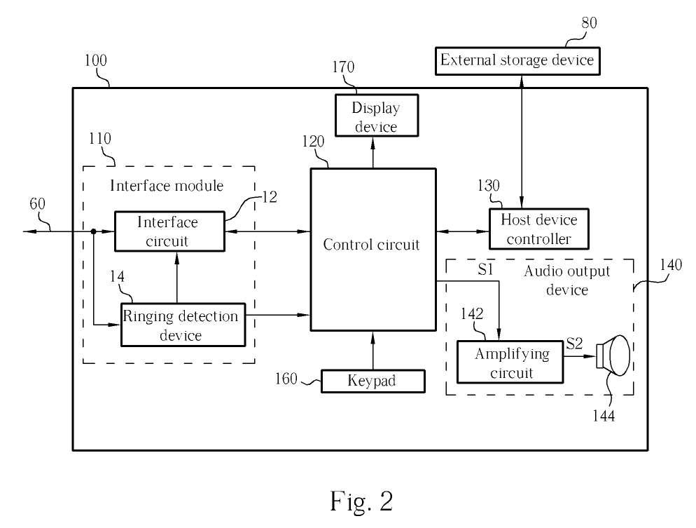

Please refer to FIG. 2. FIG. 2 is a diagram of an answering machine 100 according to a first embodiment of the present invention. The answering machine 100 comprises an interface module 110, a control circuit 120, a host device controller 130, an audio output device 140, a keypad 160, and a display device 170, where the interface module 110 comprises the interface circuit 12 and the ringing detection device 14 mentioned above, and the audio output device 140 comprises an amplifying circuit 142 and a speaker 144, and the keypad 160 comprises a plurality of keys/buttons (not shown). In this embodiment, the control circuit 120 is implemented by utilizing a microcontroller, and the display device 170 is a Liquid Crystal Display (LCD) module.

As shown in FIG. 2, the host device controller 130 is utilized for coupling to an external storage device 80, in order to access the external storage device 80 (i.e., read/write data in the external storage device 80). In this embodiment, the external storage device 80 is a storage device including a Universal Serial Bus (USB) interface, and the host device controller 130 is a host device controller complying with USB specifications accordingly, so the host device controller 130 is also referred to as the USB host device controller. In addition, the interface module 110 is utilized for coupling an external line 60. The ringing detection device 14 in the interface module 110 is utilized for performing the ringing detection on the external line 60. The control circuit 120 controls the interface circuit 12 to be in an on-hook state or an off-hook state according to the ringing detection performed by the ringing detection device 14. When the ringing detection device 14 detects ringing signals at the external line 60, the control circuit 120 controls the interface circuit 12 to be in the on-hook state or the off-hook state according to a certain criterion such as whether the number of rings of a phone-call reaches a predetermined value (e.g., three) or whether a ringing time of the phone-call reaches a predetermined time (e.g., ten seconds). When the number of rings or the ringing time of the phone-call matches the corresponding predetermined criterion mentioned above, the control circuit 120 controls the interface circuit 12 to switch from the on-hook state to the off-hook state. As a result, an incoming message (ICM) inputted via the external line 60, for example, an audio message of a caller who places the phone-call, is transmitted to the control circuit 120. The control circuit 120 controls the host device controller 130 to store an audio file corresponding to the ICM in the external storage device 80, in order to perform recording of the ICM.

The control circuit 120 is capable of further determining to stop the recording of the ICM according to at least one rule. For example, the control circuit 120 may stop the recording of the ICM when the caller presses a specific key, when the time utilized for the recording of the ICM reaches a predetermined time, or when the audio file corresponding to the ICM matches a predetermined value (e.g., the current size of the audio file reaches a predetermined value). While determining to stop the recording of the ICM, the control circuit 120 controls the interface circuit 12 to switch from the off-hook state to the on-hook state, and stops recording. The control circuit 120 of this embodiment is capable of utilizing the host device controller 130 to derive information such as the number of files stored in the external storage device 80, file names/sizes of the files stored therein, etc., and further monitor a current size of the audio file corresponding to the ICM during the process of the recording of the ICM (e.g., monitor the amount of data that has been written).

The external storage device 80 can be detached from the answering machine 100. In addition, many computer systems on the market include USB communication functionality. Computer systems without USB communication functionality may utilize interface cards to upgrade. Therefore, a user may couple the external storage device 80 to a computer system having the USB communication functionalities, in order to utilize the audio file stored in the external storage device 80.

The display device 170 is capable of being utilized for displaying information outputted by the control circuit 120, for example, the number of audio messages stored in the external storage device 80, the recording time thereof, and/or the number of audio files stored in the external storage device 80, the size of each audio file, and so on. The keypad 160 is capable of being utilized for sending a command or inputting information into the control circuit 120. When the user is going to listen to the audio file corresponding to the ICM or another audio file stored in the external storage device 80, the user may utilize the keypad 160 to control the answering machine 100, in order to play the audio file. As a result, the control circuit 120 controls the host device controller 130 to read the audio file that the user wants to hear, and generates an audio output signal S1 corresponding to the audio file. In this embodiment, the control circuit 120 triggers the host device controller 130 according to the information inputted from the keypad 160 to read from the external storage device 80 the audio file that the user wants to hear, and the audio output device 140 plays the audio output signal S1 outputted by the control circuit 120 accordingly, in order to play the audio file. In the audio output device 140 of this embodiment, the amplifying circuit 142 amplifies the audio output signal S1 to generate an amplified audio output signal S2, and the speaker 144 plays the amplified audio output signal S2 to play the audio file.

According to this embodiment, by utilizing the keypad 160, the user may control the answering machine 100 to play any audio file stored in the external storage device 80 and select one audio file as an outgoing message (OGM), where the OGM is the message that the answering machine 100 utilizes for answering the caller. If the user has selected one audio file as the OGM, before starting to perform the recording of the ICM mentioned above, the control circuit 120 controls the host device controller 130 to read the selected audio file stored in the external storage device 80, and plays the ICM at the external line 60 through the interface module 110 according to the audio file. After completely playing the OGM, the control circuit 120 starts to perform the recording of the ICM.

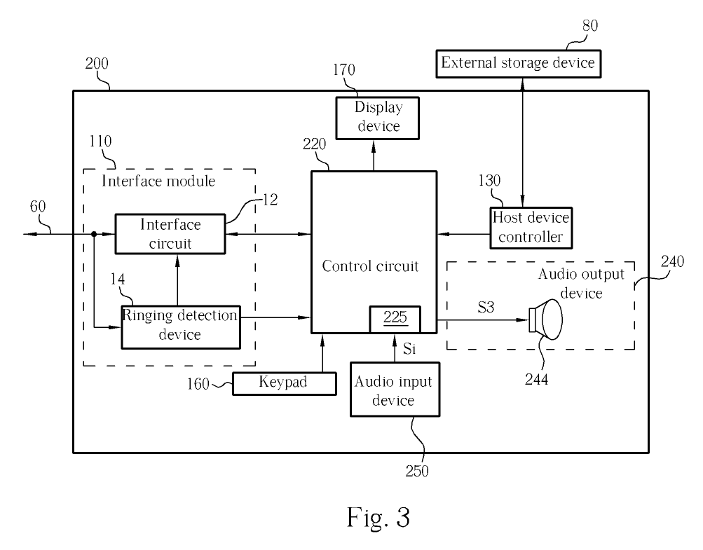

Please refer to FIG. 3. FIG. 3 is a diagram of an answering machine 200 according to a second embodiment of the present invention. The second embodiment is similar to the first embodiment, where the differences between the two embodiments are described as follows. The answering machine 200 comprises a control circuit 220 and an audio output device 240 for respectively replacing the control circuit 120 and the audio output device 140 mentioned above, where the control circuit 220 of this embodiment can also be implemented by utilizing a microcontroller. The control circuit 220 comprises an analog-to-digital converter (ADC) 225, which is installed in the microcontroller, for digitizing an audio input signal S1. Additionally, the audio output device 240 comprises a speaker 244 coupled to the control circuit 220 to receive an audio output signal S3 outputted by the control circuit 220. As the control circuit 220 of this embodiment is capable of driving the speaker 244 directly, it is not necessary to install the amplifying circuit mentioned above in the audio output device 240, i.e., the audio output signal S3 can be played by utilizing the speaker 244 without an additional amplifying circuit.

The answering machine 200 further comprises an audio input device 250. According to this embodiment, the audio input device 250 is a microphone. When the user records an audio message such as a memorandum (Memo) or the OGM mentioned above, the user may control the answering machine 200 by utilizing the keypad 160 to record the audio file that represents the Memo or the OGM. The audio input device 250 is capable of being utilized for receiving audio waves from the user to generate the audio input signal S1, and outputs the audio input signal S1 to the control circuit 220. The control circuit 220 is capable of controlling the host device controller 130 to store the audio file corresponding to the audio input signal S1 in the external storage device 80. By utilizing the keypad 160, the user may also control the answering machine 200 to record some backup audio files, and further select one audio file from all the audio files stored in the external storage device 80 as the OGM. Similar descriptions for this embodiment are not repeated here.

In different embodiments, the ADC can be installed outside the microcontroller.

In a variation of the first embodiment or the second embodiment, the external storage device is a memory card, and the host device controller is a memory card host device controller accordingly. Some computer systems on the market have card readers therein. Regarding those computer systems without any card reader, an external card read can be coupled to one of those computer systems to access the memory card. As a result, the user may further utilize the audio file(s) stored in the memory card. Similar descriptions for this variation are not repeated here.

In different embodiments, the external storage device can be a portable storage device/medium such as a USB portable FLASH drive or a portable storage medium with another kind of communication interface, where the host device controller in the answering machine is a corresponding host device controller (e.g., the USB host device controller or a host device controller complying with specifications of the communication interface mentioned above).

In another variation of the first embodiment or the second embodiment, the display device is an Organic Light Emitting Diode (OLED) module. In yet another variation of the first embodiment or the second embodiment, the display device comprises at least one seven-segment display module. Similar descriptions for these variations are not repeated here. Of course, in different embodiments, the display device can be selected from a group consisting of an LCD module, a Vacuum Fluorescent Display (VFD) module, a Polymer Light Emitting Diode (PLED) module, and a Light Emitting Diode (LED) module.

In contrast to the prior art, the answering machine of the present invention utilizes the external storage device to store the audio file representing the ICM, and the user may detach the external storage device from the answering machine of the present invention and further couple the external storage device to a computer system or another equipment with compatible communication functionalities, in order to utilize the audio file(s) stored in the external storage device.

It is another advantage of the present invention that when the answering machine of the present invention is damaged, the user may couple the external storage device to another answering machine of the present invention, so the audio files originally stored in the external storage device can be utilized at once.

It is another advantage of the present invention that the answering machine of the present invention can be a player for playing the audio file(s) stored in the external storage device.

It is noted that the present invention can also be implemented by integrating the host device controller of the present invention into the architecture of the digital answering machine in the art, and by providing a connection port coupled to the host device controller, where the connection port is capable of being utilized for connecting the external storage device. As a result of this implementation choice, providing the answering machine with the external storage device for data accessing while maintaining a large portion of the architecture of the digital answering machine as found in the art to be as unvaried as possible.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An answering machine comprising:
an interface module for coupling an external line;
a host device controller for coupling to an external storage device, wherein the host device controller is utilized for accessing the external storage device;
a control circuit coupled to the interface module and the host device controller for controlling the host device controller to access the external storage device; and
an audio output device coupled to the control circuit, wherein the audio output device is capable of being utilized for playing an audio message stored in the external storage device.

2. The answering machine of claim 1, further comprising:
an audio input device coupled to the control circuit for receiving audio waves to generate an audio input signal.

3. The answering machine of claim 2, wherein the audio input device is a microphone.

4. The answering machine of claim 1, wherein the control circuit comprises a microcontroller.

5. The answering machine of claim 1, wherein the control circuit comprises an analog-to-digital converter (ADC).

6. The answering machine of claim 1, wherein the interface module comprises:
an interface circuit;
wherein the control circuit controls the interface circuit to be in an on-hook state or an off-hook state according to a predetermined rule.

7. The answering machine of claim 6, wherein the interface module further comprises:
a ringing detection device for performing ringing detection on the external line;
wherein the control circuit controls the interface circuit to switch from the on-hook state to the off-hook state according to the ringing detection performed by the ringing detection device.

8. The answering machine of claim 1, wherein the external storage device is a storage device including a Universal Serial Bus (USB) interface, and the host device controller is a USB host device controller.

9. The answering machine of claim 1, wherein the external storage device is a memory card, and the host device controller is a memory card host device controller.

10. The answering machine of claim 1, wherein the audio output device comprises:
an amplifying circuit for amplifying an audio output signal corresponding to the audio file; and
a speaker coupled to the amplifying circuit for playing the amplified audio output signal.

11. The answering machine of claim 1, wherein the audio output device comprises a speaker.

12. The answering machine of claim 1, further comprising:
a keypad coupled to the control circuit for sending a command or inputting information into the control circuit.

13. The answering machine of claim 1, further comprising:
a display device coupled to the control circuit for displaying information outputted by the control circuit.

14. The answering machine of claim 13, wherein the display device is selected from a group consisting of a Liquid Crystal Display (LCD) module, a Vacuum Fluorescent Display (VFD) module, a Polymer Light Emitting Diode (PLED) module, and a Light Emitting Diode (LED) module.
